(19) United States
(12) Patent Application Publication
(10) Pub. No.: US 2026/0246737 A1
(43) Pub. Date: Aug. 20, 2026

(54) Congestion control algorithm selection

(71) Applicant: Mellanox Technologies, Ltd., Yokneam (IL)

(72) Inventors: Adi Horowitz, Lehavot Habashan (IL); Yuval Shpigelman, Netanya (IL); Lior Maman, Herzliya (IL); Omer Nissim, Givatayim (IL); Omer Shabtai, Tel Aviv (IL); Matty Kadosh, Hadera (IL)

(21) Appl. No.: 19/443,078

(22) Filed: Jan. 8, 2026

Related U.S. Application Data
(60) Provisional application No. 63/760,662, filed on Feb. 20, 2025.

(51) Int. Cl. H04L 47/122; H04L 43/067; H04L 47/24

(52) U.S. Cl. CPC H04L 47/122; H04L 43/067; H04L 47/24

(57) ABSTRACT

In one embodiment, a network device comprises a memory to store a set of congestion control algorithms, at least one processor to receive data associated with a network flow, automatically select a congestion control algorithm from the set of congestion control algorithms based on the data of the network flow, and apply the selected congestion control algorithm to control traffic of the network flow.

### RELATED APPLICATION INFORMATION

The present application claims benefit of US Provisional Patent Application S/N 63/760,662 of Horowitz, et al., filed 20 Feb. 2025, the disclosure of which is hereby incorporated herein by reference.

### FIELD OF THE DISCLOSURE

The present disclosure relates to computer networks, and more particularly but not exclusively to congestion control.

### BACKGROUND

Computer networks facilitate the exchange of data between interconnected devices. As network traffic increases, congestion can occur when the volume of data exceeds the capacity of network links or devices. Congestion control mechanisms aim to manage network traffic to prevent or mitigate such congestion.

Congestion control typically involves adjusting the rate at which data is transmitted based on network conditions. This helps maintain efficient network utilization while avoiding overload situations that can lead to packet loss, increased latency, and reduced throughput.

Various congestion control algorithms have been developed to address different network scenarios and requirements. These algorithms often rely on feedback mechanisms to detect congestion and adjust transmission rates accordingly. Common indicators used by congestion control algorithms include packet loss, round-trip time (RTT) measurements, and explicit congestion notifications from network devices.

One approach to congestion control involves a slow start phase, where the transmission rate is gradually increased until congestion is detected. Once congestion is observed, the algorithm enters a congestion avoidance phase, where it more cautiously adjusts the transmission rate to find a balance between throughput and network stability.

Congestion control can be implemented at different layers of the network stack, including the transport layer protocols like TCP (Transmission Control Protocol).

As networks evolve to support diverse applications with varying requirements, congestion control mechanisms continue to be an area of active research and development. Challenges include adapting to dynamic network conditions, ensuring fairness among competing flows, and optimizing performance for different types of traffic and network topologies.

### OVERVIEW

There is provided in accordance with an embodiment of the present disclosure, a network device, comprising a network interface to send or receive a given network flow over a network, at least one processor to receive data associated with the given network flow, automatically select a given congestion control algorithm from a set of congestion control algorithms based on the data of the given network flow, and apply the selected given congestion control algorithm to control traffic of the given network flow.

Further in accordance with an embodiment of the present disclosure, the at least one processor is further to receive data associated with another network flow, automatically select another congestion control algorithm from the set of congestion control algorithms based on the data of the other network flow, wherein the other congestion control algorithm is different from the given congestion control algorithm selected for the given network flow, and apply the other congestion control algorithm to control traffic of the other network flow.

Still further in accordance with an embodiment of the present disclosure, the data associated with the network flow comprises congestion control statistics, and wherein the at least one processor automatically selects the given congestion control algorithm based on the congestion control statistics.

Additionally, in accordance with an embodiment of the present disclosure, the data associated with the given network flow comprises at least one round-trip time (RTT) measurement, and wherein the at least one processor automatically selects the given congestion control algorithm based on the at least one RTT measurement.

Moreover, in accordance with an embodiment of the present disclosure, the data associated with the given network flow comprises application data, and wherein the at least one processor automatically selects the given congestion control algorithm based on the application data.

Further in accordance with an embodiment of the present disclosure, the data associated with the given network flow comprises quality of service (QoS) information, and wherein the at least one processor automatically selects the given congestion control algorithm based on the QoS information.

Still further in accordance with an embodiment of the present disclosure, the data associated with the given network flow comprises information indicating a distance to a remote node associated with the given network flow, and wherein the at least one processor automatically selects the given congestion control algorithm based on the distance to the remote node.

Additionally, in accordance with an embodiment of the present disclosure, the at least one processor is further to receive data associated with another network flow, the data comprising information indicating a distance to another remote node associated with the other network flow, automatically select another congestion control algorithm from the set of congestion control algorithms based on the distance to the other remote node, wherein the other congestion control algorithm is different from the given congestion control algorithm selected for the given network flow, and apply the other congestion control algorithm to control traffic of the other network flow.

Moreover, in accordance with an embodiment of the present disclosure, the at least one processor is further to monitor performance metrics of the network flow while applying the selected given congestion control algorithm, and dynamically switch to a different congestion control algorithm from the set of congestion control algorithms based on the monitored performance metrics.

Further in accordance with an embodiment of the present disclosure, the data associated with the given network flow comprises information about network topology between the network device and a destination of the given network flow, and wherein the at least one processor automatically selects the given congestion control algorithm based on the network topology information.

Still further in accordance with an embodiment of the present disclosure, the network interface is to be connected to multiple network planes, and the at least one processor is to maintain separate congestion control contexts for each of the multiple network planes when communicating with a remote device connected to the multiple network planes, and maintain a single congestion control context when communicating with a remote device connected to a single network plane.

There is provided in accordance with another embodiment of the present disclosure, a method comprising sending or receiving a given network flow over a network, receiving data associated with the given network flow, automatically selecting a given congestion control algorithm from a set of congestion control algorithms based on the data of the given network flow, and applying the selected given congestion control algorithm to control traffic of the given network flow.

Further in accordance with an embodiment of the present disclosure, the method further comprises receiving data associated with another network flow, automatically selecting another congestion control algorithm from the set of congestion control algorithms based on the data of the other network flow, wherein the other congestion control algorithm is different from the given congestion control algorithm selected for the given network flow, and applying the other congestion control algorithm to control traffic of the other network flow.

Still further in accordance with an embodiment of the present disclosure, the data associated with the given network flow comprises congestion control statistics, and wherein automatically selecting the given congestion control algorithm is based on the congestion control statistics.

Additionally, in accordance with an embodiment of the present disclosure, the data associated with the given network flow comprises at least one round-trip time (RTT) measurement, and wherein automatically selecting the given congestion control algorithm is based on the at least one RTT measurement.

Moreover, in accordance with an embodiment of the present disclosure, the data associated with the given network flow comprises application data, and wherein automatically selecting the given congestion control algorithm is based on the application data.

Further in accordance with an embodiment of the present disclosure, the data associated with the given network flow comprises quality of service (QoS) information, and wherein automatically selecting the given congestion control algorithm is based on the QoS information.

Still further in accordance with an embodiment of the present disclosure, the data associated with the given network flow comprises information indicating a distance to a remote node associated with the given network flow, and wherein automatically selecting the given congestion control algorithm is based on the distance to the remote node.

Additionally, in accordance with an embodiment of the present disclosure, the method further comprises monitoring performance metrics of the given network flow while applying the selected given congestion control algorithm, and dynamically switching to a different congestion control algorithm from the set of congestion control algorithms based on the monitored performance metrics.

Moreover, in accordance with an embodiment of the present disclosure, the data associated with the given network flow comprises information about network topology between a network device and a destination of the given network flow, and wherein automatically selecting the given congestion control algorithm is based on the network topology information.

Further in accordance with an embodiment of the present disclosure, the method further comprises maintaining separate congestion control contexts for each of multiple network planes when communicating with a remote device connected to the multiple network planes, and maintaining a single congestion control context when communicating with a remote device connected to a single network plane.

### BRIEF DESCRIPTION OF THE DRAWINGS

The present disclosure will be understood from the following detailed description, taken in conjunction with the drawings in which:

FIG. 1 is a simplified pictorial illustration of a network architecture constructed and operative in accordance with an embodiment of the present disclosure;

FIG. 2 is a more detailed view of a network interface controller of FIG. 1, according to an embodiment of the present disclosure;

FIG. 3 is a flowchart including steps in a method of operation of the system of FIG. 1, in accordance with an embodiment of the present disclosure;

FIG. 4 is a block diagram illustrating a system configured for congestion control context selection based on network plane information, in accordance with an embodiment of the present disclosure;

FIG. 5 is a flowchart including steps in a method for managing congestion control across multiple network planes, in accordance with an embodiment of the present disclosure; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

Current congestion control algorithms in computer networks face challenges in heterogeneous deployments, particularly in data centers spanning multiple buildings or regions connected by long-haul links. These algorithms typically apply a single approach across all connections, regardless of their characteristics. This one-size-fits-all method can lead to suboptimal performance, especially when dealing with both short intra-data center connections and long inter-data center links simultaneously.

The problem arises from the differences in network characteristics between these connection types. Intra-data center connections typically have low latency and high bandwidth, while inter-data center links may have higher latency and different congestion patterns. Applying the same congestion control algorithm to both scenarios can result in inefficient bandwidth utilization, increased latency, and reduced overall network performance.

Possible solutions could involve manually configuring different algorithms for different connection types or developing a new, complex algorithm that attempts to handle all scenarios. However, these approaches have drawbacks such as increased management overhead, lack of flexibility, or potential compromises in performance for certain connection types.

Embodiments of the present disclosure address at least some of the above drawbacks by providing a system and method that dynamically selects congestion control algorithms based on connection characteristics or application requirements (e.g., quality of service (QoS)).

In some embodiments, the system measures the round-trip time (RTT) of a connection and selects an appropriate congestion control algorithm based on predefined RTT thresholds. This allows the system to automatically apply different algorithms optimized for short or long-distance connections.

In some cases, the selection of the congestion control algorithm is based on quality of service (QoS) markings assigned by the application. This approach allows applications to influence the congestion control behavior based on their specific requirements or knowledge of the expected traffic patterns.

In some embodiments, the system may select congestion control approaches based on network plane configuration information. When communicating with remote devices connected to multiple network planes, the system maintains separate congestion control contexts for each plane, allowing independent management of congestion control state and variables for each network path. When communicating with remote devices connected to a single network plane, the system maintains a unified congestion control context. This network plane-based context management allows for optimized traffic management across heterogeneous network environments where both multi-plane and single-plane configurations coexist, enabling the system to adapt its congestion control strategy based on the network plane characteristics of the remote device.

The advantages of this solution include improved network performance, better utilization of available bandwidth, and reduced latency for diverse network deployments. By tailoring the congestion control approach to the specific characteristics of each connection, the system can achieve more efficient and responsive data transmission across heterogeneous network environments.

Embodiments of the present disclosure improve the way a computer or other processing device works by: providing better computer performance; providing higher processing speed; providing less latency; reducing bandwidth requirements over network connections; increasing data access speed; and reducing power consumption.

### SYSTEM DESCRIPTION

The present disclosure relates to systems and methods for dynamically selecting and applying congestion control algorithms in network devices. Before describing the details of the disclosure, it may be helpful to define some terms used throughout this disclosure.

As used herein, the term "network device" may refer to a hardware component or system that facilitates communication and data transfer within a computer network. A network device may include a network interface controller (NIC), a data processing unit (DPU), a smart NIC including a NIC and one or more processing cores, or a network switch.

As used herein, the term "network interface" may refer to a hardware or software component that enables a device to connect to and communicate over a network. A network interface may include an Ethernet port or a wireless adapter that facilitates the transmission and reception of data packets.

As used herein, the term "processor" may refer to a computational unit capable of executing instructions and performing data processing tasks. A processor may include a central processing unit (CPU) or processing cores within a network interface controller that handle network traffic management and congestion control algorithm execution.

As used herein, the term "network flow" may refer to a sequence of related packets transmitted between a source and a destination over a network. A network flow may be identified by a combination of attributes such as source IP address, destination IP address, source port, destination port, and protocol type, or may represent a bidirectional stream of data associated with a specific application or communication session. In some cases, a network flow may be bidirectional, encompassing packets traveling in both directions between the communicating endpoints.

As used herein, the term "network" may refer to an interconnected system of devices that can communicate and exchange data with each other. A network may include a local area network (LAN) within a data center or a wide area network (WAN) connecting geographically separated data centers.

As used herein, the term "traffic" may refer to the flow of data packets or information transmitted across a network.

As used herein, the term "send" may refer to the action of transmitting data packets or information from one network device to another over a network. Sending may include a network interface controller transmitting packets to a remote device or an application sending data through a network connection.

As used herein, the term "receive" may refer to the action of accepting or obtaining data packets or information from another network device over a network. Receiving may include a network interface controller accepting incoming packets from a remote device or processing cores receiving data associated with a network flow.

As used herein, the term "data" may refer to information or content that is transmitted, processed, or stored within a network system. Data may include network flow characteristics such as round-trip time measurements, network plane identification information, or application-specific information such as quality of service parameters.

As used herein, the term "congestion control statistics" may refer to quantitative measurements or metrics that indicate the state or performance of network traffic management. Congestion control statistics may include round-trip time (RTT) measurements or packet loss rates that are used to assess network conditions and select appropriate congestion control settings and/or algorithms.

As used herein, the term "round-trip time (RTT) measurement" may refer to the time it takes for a network packet to travel from a source to a destination and back again. An RTT measurement may be used to determine the distance between network devices or to assess network latency for congestion control algorithm selection.

As used herein, the term "application data" may refer to information generated by or associated with software applications that utilize network resources. Application data may include quality of service (QoS) information provided by an application or configuration parameters that influence congestion control algorithm selection.

As used herein, the term "quality of service (QoS) information" may refer to data that specifies the performance requirements or priority levels for network traffic. QoS information may include latency requirements for real-time applications or bandwidth allocation preferences that guide congestion control algorithm selection.

As used herein, the term "distance" may refer to a measure of separation between network devices or nodes, which may be physical or logical. Distance may be determined from round-trip time measurements between data centers or derived from the physical length of cables connecting network devices.

As used herein, the term "network topology information" may refer to data describing the arrangement, structure, or layout of network components and their interconnections. Network topology information may include the physical cable lengths between network devices or the logical paths that data packets traverse through a network.

As used herein, the term "performance metrics" may refer to quantitative measures that indicate the effectiveness or efficiency of network operations. Performance metrics may include throughput measurements, latency values, or packet loss rates that are monitored to assess the success of applied congestion control algorithms.

As used herein, the term "remote node" may refer to a network device or endpoint that is located at a different physical or logical location from the local device. A remote node may include a network device in a geographically separated data center or a destination device that communicates with the local network device over a network connection.

As used herein, the term "destination" may refer to the target endpoint or final recipient of data transmission in a network communication. A destination may include a specific network device identified by an IP address or a remote server that receives data packets from a source device.

As used herein, the term "set of congestion control algorithms" may refer to a collection of different techniques or methods available for managing network traffic and preventing congestion. A set of congestion control algorithms may include algorithms with different parameter values such as varying window sizes or algorithms with different underlying logic such as delay-based versus loss-based approaches.

As used herein, the term "automatically select" may refer to a process where a network device or system chooses a congestion control algorithm without direct human intervention. Automatically selecting may involve analyzing round-trip time measurements against predefined thresholds or using machine learning techniques to determine the most appropriate algorithm based on network conditions.

As used herein, the term "apply" may refer to the action of implementing or putting into effect a chosen congestion control algorithm for managing network traffic. Applying may include adjusting transmission rates based on algorithm specifications or configuring network parameters according to the selected congestion control strategy.

As used herein, the term "control" may refer to the management or regulation of network traffic flow to optimize performance and prevent congestion. Control may include adjusting transmission window sizes based on network conditions or modifying data transmission rates to maintain efficient network utilization.

As used herein, the term "monitor" may refer to the continuous observation or measurement of network conditions and performance indicators. Monitoring may include tracking throughput and latency metrics during data transmission or observing packet loss rates to assess the effectiveness of applied congestion control algorithms.

As used herein, the term "dynamically switch" may refer to the ability to change from one congestion control algorithm to another during an active network connection based on changing conditions. Dynamically switching may include transitioning from a long-haul algorithm to a short-haul algorithm when RTT measurements fall below a defined threshold or adapting to different network plane characteristics in real-time.

As used herein, the term "Quality of Service (QoS)" may refer to the overall performance of a network or service as experienced by users. QoS may include assigning priorities to different types of data traffic to ensure higher priority traffic receives preferential treatment over lower priority traffic in the network. This prioritization can affect various aspects of network performance, including error rates, bandwidth allocation, throughput, transmission delay, availability, and jitter.

As used herein, the term "Congestion Control" may refer to techniques and mechanisms used to manage network traffic, e.g., adjusting the transmission rate of data, when the network is overloaded. The goal of congestion control is to prevent network collapse by reducing the rate of packet transmission.

As used herein, the term "Congestion Control Algorithm" may refer to a specific implementation of congestion control techniques. These algorithms determine how a network device may adjust its transmission rate in response to network conditions to avoid or mitigate congestion. Congestion control algorithms can be defined in multiple ways. One approach involves using the same underlying logic with one or more different values of the algorithm parameters to create different congestion control algorithms. For example, two algorithms may use the same basic congestion window adjustment mechanism but with different increase/decrease factors. Another approach involves algorithms with different underlying logic altogether, such as explicit congestion notification (ECN) based congestion control versus delay-based congestion control. This flexibility in defining congestion control algorithms allows for tailored solutions to various network scenarios and requirements.

As used herein, the term "multiple network planes" may refer to a network configuration that includes two or more separate, parallel network paths or channels that provide redundant or alternative communication routes between network devices. Multiple network planes may include separate physical network infrastructures within a data center that allow traffic to be distributed across different paths, or parallel network connections that provide increased bandwidth and fault tolerance for high-performance computing applications. A network plane of the multiple network planes may include multiple paths from a source to a destination.

As used herein, the term "single network plane" may refer to a single physical network configuration. The single network plane may include one or more paths over the single physical network configuration from a source to a destination..

As used herein, the term "separate congestion control contexts" may refer to independent sets of congestion control state information, and variable values that are maintained individually for each network plane in a multi-plane configuration. Separate congestion control contexts may include maintaining distinct congestion window values, round-trip time measurements, and packet loss counters for each network plane, or independent tracking of acknowledgments and retransmission timers for different network paths to enable optimized congestion management per plane.

As used herein, the term "single congestion control context" may refer to a unified set of congestion control state information, and variable values that is maintained collectively for all network communication when using a single network plane configuration. A single congestion control context may include maintaining one congestion window value and one set of round-trip time measurements for all traffic to a particular destination, or using unified packet loss tracking and acknowledgment management when communicating through a single network path.

As used herein, the term "congestion control approach" may refer to the overall strategy or method used to manage network traffic and prevent congestion based on the network plane configuration and remote device characteristics. A congestion control approach may include the decision to use separate congestion control contexts for multi-plane communications or a single context for single-plane communications, or the selection of specific congestion control algorithms and parameter settings based on the network topology and destination device capabilities.

As used herein, the term "congestion control context configuration" may refer to the specific arrangement or setup of congestion control state management that is determined based on the network plane characteristics of the communication path and destination device. A congestion control context configuration may include the determination of whether to maintain separate contexts for each network plane or a unified context for single-plane communication, or the specific parameters and variables that are allocated and managed for congestion control state tracking based on the network topology.

As used herein, the term "network plane identification information" may refer to data or metadata, e.g., provided by an external source, that indicates the network plane characteristics and configuration associated with a particular network flow or communication path. Network plane identification information may include indicators that specify whether a network flow is associated with multiple network planes or a single network plane, or data that identifies the specific network planes or paths that are available for communication with a particular remote device.

In some cases, the network device described in this disclosure may be a network interface controller (NIC). The NIC may be configured to store and execute multiple congestion control algorithms. These algorithms may be loaded onto the NIC, allowing for efficient and flexible congestion management.

The NIC may have the capability to select different congestion control algorithms for different network flows. In some cases, this selection may be performed on a per-connection basis, allowing for fine-grained control over network traffic management.

In some implementations, the NIC may be capable of disabling congestion control for one or more flows. This feature may be useful in scenarios where congestion control is unnecessary or potentially detrimental to performance.

The NIC may also have the ability to switch congestion control algorithms during an active connection. This dynamic switching capability may allow the NIC to adapt to changing network conditions or application requirements in real-time.

By providing these capabilities, the NIC may offer improved flexibility and performance in managing network congestion across a wide range of network conditions and application requirements.

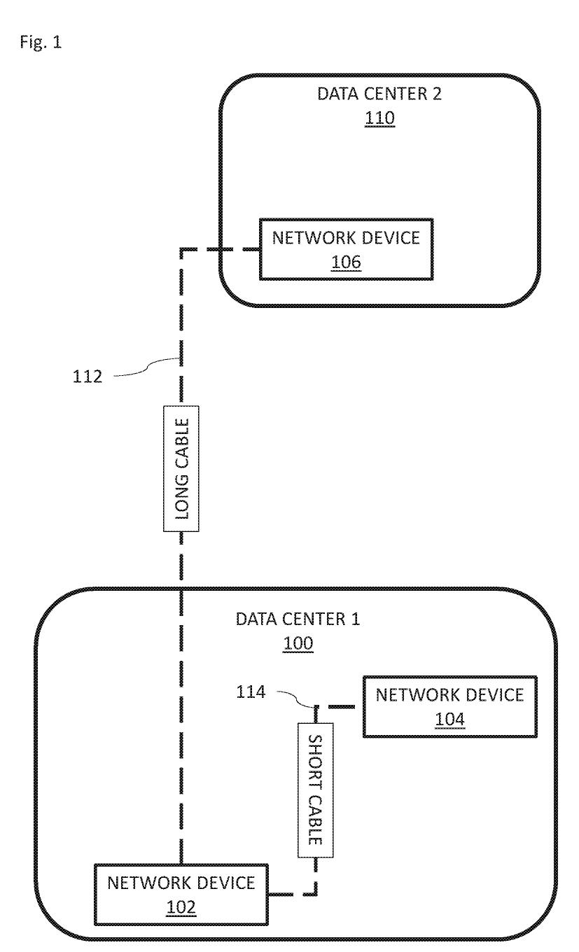

Reference is now made to FIG. 1, which is an illustration of a network architecture comprising multiple data centers 100, 110 and network devices. Two data centers and three network devices are shown in FIG. 1 for the sake of simplicity. Any suitable number of data centers and network devices may be included.

The network architecture includes a first data center 100 and a second data center 110. The first data center 100 contains a first network device 102 and a second network device 104. The second data center 110 includes a third network device 106.

In some cases, the first network device 102 and the second network device 104 within the first data center 100 may communicate via a short cable 114. The short cable 114 may span a relatively short distance within the first data center 100, facilitating local communication between network devices.

The first data center 100 may connect to the second data center 110 through a long cable 112. The long cable 112 may extend between the first network device 102 and the third network device 106, enabling data transmission between geographically separated data centers.

The network architecture allows for both intra-data center communication and inter-data center communication. In some cases, topology information (e.g., the length of the cables connecting network devices) may be used in selecting appropriate congestion control algorithms.

For example, a network device may receive data (e.g., RTT) associated with a network flow that includes information indicating a distance to a remote node associated with the network flow. The distance information may be derived from measurements of the physical cable length. In some cases, round-trip time (RTT) probes may be used to measure the physical cable length.

Based on this distance information, the network device may automatically select a congestion control algorithm. For instance, the network device may select one algorithm for flows traversing the short cable 114 within the first data center 100, and a different algorithm for flows traversing the long cable 112 between the first data center 100 and the second data center 110.

In some cases, a network device may receive data associated with multiple network flows. For example, the network device may receive data associated with a first network flow indicating a distance to a first remote node, and data associated with a second network flow indicating a distance to a second remote node. The network device may automatically select different congestion control algorithms for these flows based on their respective distances.

The selection of congestion control algorithms based on network topology (e.g., distances to remote nodes) allows the network devices to optimize traffic control for different types of network flows. This approach may help manage congestion more effectively in heterogeneous network environments where both short-distance and long-distance communications occur simultaneously.

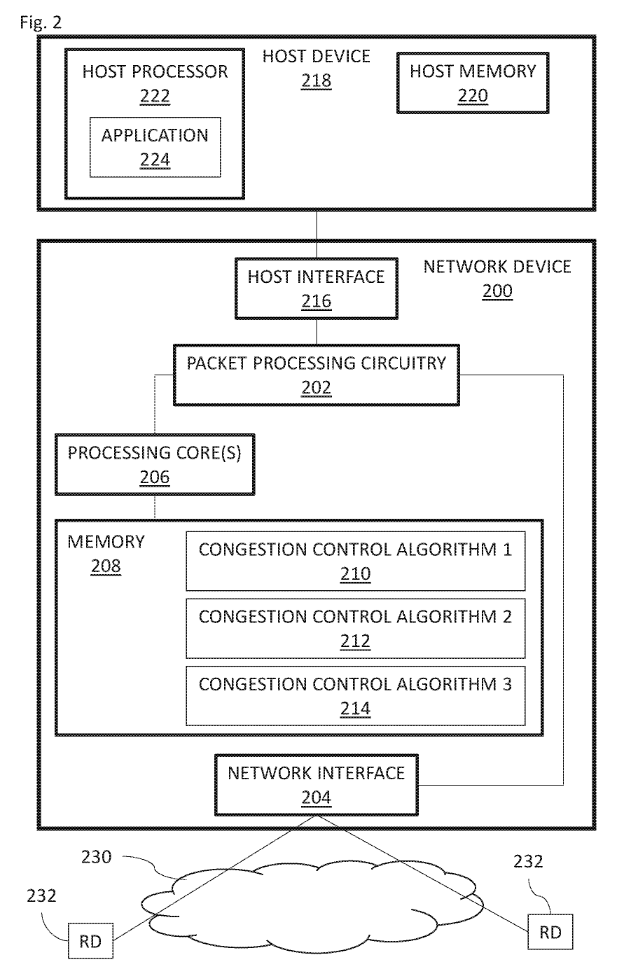

Reference is now made to FIG. 2, which is a block diagram illustrating a network device 200 (e.g., network interface controller (NIC)) and a host device 218. The network device 200 is referred to as NIC 200 for the sake of simplicity.

The NIC 200 may include packet processing circuitry 202 connected to a network interface 204 and one or more processing cores 206. The network interface 204 is configured to send or receive packets of one or more network flows over a network 230 to or from remote devices 232 (two shown for the sake of simplicity). The packet processing circuitry 202 may process network packets flowing between the network interface 204 and a host interface 216.

The NIC 200 may include memory 208 coupled to the processing core(s) 206. The memory 208 may store a set of congestion control algorithms, including a congestion control algorithm 210, a congestion control algorithm 212, and a congestion control algorithm 214. Three congestion control algorithms are shown in the example of FIG. 2. The set of congestion control algorithms may include two or more, and any suitable number of congestion control algorithms. The processing core(s) 206 may execute these congestion control algorithms to manage network traffic.

In some cases, the processing core(s) 206 may receive data associated with a network flow through the network interface 204 and/or the host interface 216.

The data associated with the network flow may comprise any suitable data, such as application data, e.g., quality of service (QoS) information, and/or congestion control statistics, e.g., at least one round-trip time (RTT) measurement.

Based on this data, the processing core(s) 206 may automatically select a congestion control algorithm from the set of congestion control algorithms stored in the memory 208. The congestion control algorithm selected for a given network flow may then be applied to control traffic of that network flow.

The host device 218 may connect to the NIC 200 through the host interface 216 via a suitable data bus, such as Peripheral Component Interconnect Express (PCIe). The host device 218 may include host memory 220 and a host processor 222. The host processor 222 may run an application 224 that communicates through the NIC 200. The application 224 may provide the data about one or more network flows to the processing core(s) 206.

In some cases, the processing core(s) 206 may receive data associated with a second network flow, and so on. The processing core(s) 206 may automatically select a second congestion control algorithm from the set of congestion control algorithms based on the data of the second network flow. The second congestion control algorithm may be different from the congestion control algorithm selected for the first network flow. The processing core(s) 206 may then apply the second congestion control algorithm to control traffic of the second network flow.

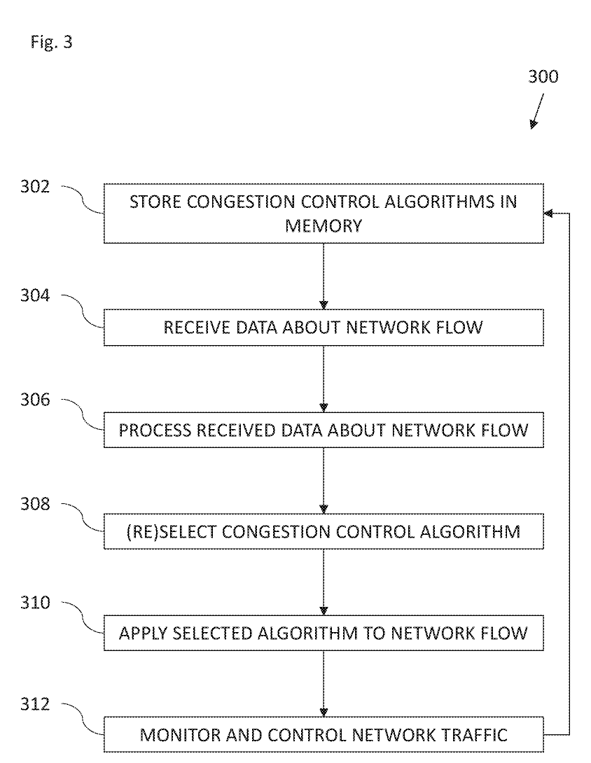

The selection of congestion control algorithms may be based on various factors. For example, if the data associated with the network flow comprises application data (e.g., QoS information), the processing core(s) 206 may automatically select the congestion control algorithm based on this application data. For example, the QoS information may indicate or hint to the distance to the destination of a given network flow or may indicate the congestion control algorithm that should be selected. Similarly, if the data includes congestion control statistics (e.g., RTT), the processing core(s) 206 may use the congestion control statistics to automatically select the appropriate congestion control algorithm. The selection of the congestion control algorithms is described in more detail with reference to FIG. 3.

By dynamically selecting and applying the congestion control algorithms based on data associated with network flows, the NIC 200 may optimize network performance for different types of traffic and network conditions.

Reference is now made to FIG. 3, which is a flowchart illustrating a method 300 for managing network congestion control. The method 300 may be implemented by a network device, such as the network device 200 shown in FIG. 2. The processing core(s) 206 of the network device 200 may be configured to perform one or more of the steps of the method 300.

The method 300 begins with a step 302 of storing a set of congestion control algorithms in memory 208. In some cases, the set of congestion control algorithms may include algorithms with different parameter values, as described in more detail below. For example, for some congestion control algorithms, e.g., ZTRCC, which is commercially available from NVIDIA Corp., the transmission rate is a function of a transmission window divided by RTT. A first algorithm may be based on ZTRCC, using a larger window for long cables, while a second algorithm may be based on ZTRCC using a smaller window for short cables. This may allow both algorithms to recover to the ideal rates for the respective flows at around the same time. Additionally, or alternatively, the set of congestion control algorithms may include algorithms with different underlying congestion control logic.

A step 304 includes receiving data associated with a network flow. The data may comprise various types of information, including congestion control statistics (e.g., at least one round-trip time (RTT) measurement) for a connection associated with the network flow, or hop count which provides an indication of the distance to the destination. In some cases, the RTT measurement may be used to determine the distance between the network device and a remote node associated with the network flow. The data may comprise application data such as QoS information. As part of the queue pair (QP) connection establishment phase handled by the application running on the host device, the application may determine which congestion control algorithm to use and encode this in data supplied to the network device 200 to select the congestion control algorithm. This may be used to ensure backward compatibility, for example, if a peer device does not support advanced congestion control features that require specific firmware (FW), hardware (HW), or software (SW) versions, the application will automatically fall back to selecting an older congestion control algorithm.

A step 306 involves processing the received data. This processing may include analyzing the congestion control statistics such as RTT measurements, and/or application data such as QoS information, to determine characteristics of the network flow.

Based on the processed data, a step 308 automatically selects a congestion control algorithm from the set of stored algorithms based on data of the network flow. The selection may be based on various factors, including the congestion control statistics (e.g., RTT measurements) and/or application data (e.g., QoS information). For example, if the RTT measurement exceeds a threshold, such as a LONG_HAUL_RTT_LOWER_BOUND parameter, the method 300 may select an algorithm optimized for long-haul connections. Conversely, if the RTT measurement is below the threshold, an algorithm optimized for short-haul connections may be selected.

As used herein, the term "automatically" selecting may refer to a process where a network device or system chooses a congestion control algorithm without direct human intervention. This selection process may be based on predefined criteria, rules, or algorithms that analyze various network parameters, flow characteristics, or other relevant data. The automatic selection may occur in real-time or near real-time as network conditions change or new data becomes available. In some cases, the automatic selection may involve machine learning techniques or adaptive algorithms that improve selection accuracy over time based on observed network performance.

As previously mentioned, application data such as Quality of Service (QoS) information may be used to select the congestion control algorithm. For instance, if the QoS information indicates a priority for low latency, the method 300 may select an algorithm that prioritizes reducing delay over maximizing throughput. Conversely, for applications that require high throughput but can tolerate some latency, an algorithm that focuses on maximizing bandwidth utilization may be chosen. This approach allows the congestion control mechanism to adapt to network conditions and to the specific requirements of the applications generating the network traffic.

A step 310 applies the selected congestion control algorithm to control traffic of the network flow. This may involve adjusting transmission rates, window sizes, or other parameters based on the algorithm's specifications.

The method 300 continues with a step 312 of monitoring and controlling the network traffic using the applied congestion control algorithm. During this step, performance metrics of the network flow may be monitored. These metrics may include throughput, latency, packet loss rate, or other relevant indicators of network performance.

The steps of method 300 may be repeated for another network flow in which another (e.g., different) congestion control algorithm is selected for that other network flow, and so on. The steps of method 300 may be repeated for two or more network flows, and so on.

In some cases, the method 300 may dynamically switch to a different congestion control algorithm from the set of stored algorithms for a given network flow based on the monitored performance metrics. For example, a flow may be initially be assigned a long-haul congestion control algorithm, and switch to a short-haul congestion control algorithm when RTT measurements fall below the defined threshold.

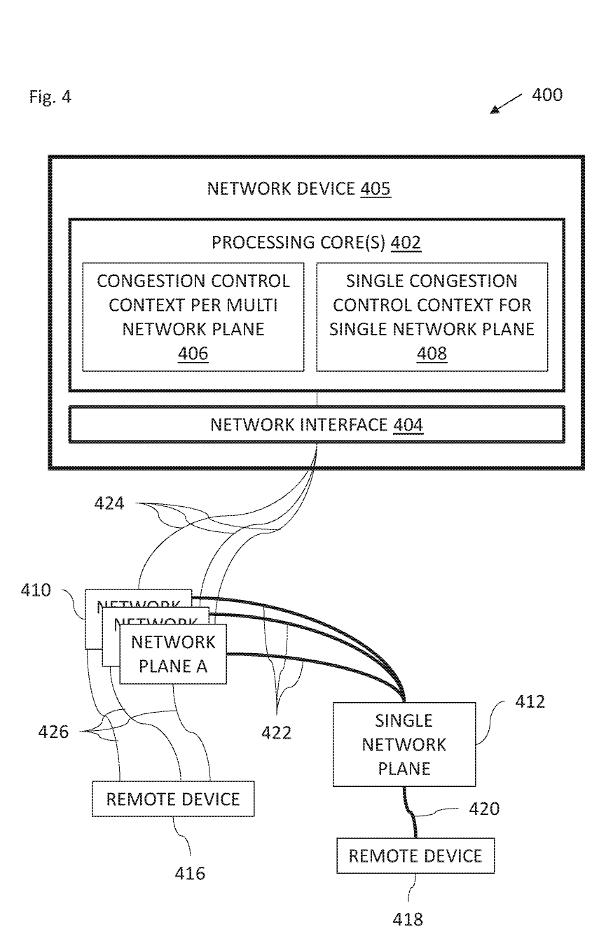

Reference is now made to FIG. 4, which is a block diagram illustrating a system 400 configured for congestion control context selection based on network plane information. The system 400 includes a network device 405 that may comprise processing core(s) 402 and a network interface 404. The network device 405 may be implemented as a network interface controller (NIC), a data processing unit (DPU), a smart NIC, or a network switch. Network device may similar functionality as network device 200.

The processing core(s) 402 may include a congestion control context per multi network plane 406 and a single congestion control context for single network plane 408. The congestion control context per multi network plane 406 may be configured to maintain separate congestion control contexts for each plane in a multi-plane network configuration. The single congestion control context for single network plane 408 may be configured to maintain a unified congestion control context when communicating with devices connected via a single network plane.

The network interface 404 may be configured to be connected to multi network planes 410 via connections 424. The multi network planes 410 may represent multiple separate network paths or planes that provide redundant or parallel communication channels. The multi network planes 410 may connect to a remote device 416 via connections 426, enabling communication through multiple parallel network paths. The multi network planes 410 may also connect to a single network plane 412 via connections 422. The single network plane 412 may connect to a remote device 418 via a connection 420.

The processing core(s) 402 may be configured to maintain separate congestion control contexts for each of the multiple network planes when communicating with the remote device 416 connected to the multi network planes 410. The processing core(s) 402 may maintain the single congestion control context 408 when communicating with the remote device 418 connected to the single network plane 412. This approach allows the network device 405 to adapt congestion control strategies based on the network plane configuration of the destination device.

With continued reference to FIG. 4, the processing core(s) 402 may be configured to receive data associated with network flows comprising network plane identification information indicating whether a given network flow is associated with the multiple network planes or the single network plane. This network plane identification information may enable the processing core(s) 402 to determine the appropriate congestion control context configuration for each network flow.

The processing core(s) 402 may be further configured to receive data associated with another network flow, where the data comprises information indicating that the other network flow is associated with a different network plane configuration than the given network flow. In some cases, the processing core(s) 402 may automatically determine whether to maintain separate congestion control contexts or a single congestion control context for the other network flow based on whether a destination remote device for the other network flow is connected to multiple network planes or a single network plane. The processing core(s) 402 may apply a congestion control approach to the other network flow based on the determined congestion control context configuration.

In alternative embodiments, the network device 405 may be implemented as a network interface controller (NIC) with packet processing circuitry connected to the network interface 404 and the processing core(s) 402. In some cases, the network device 405 may be implemented as a data processing unit (DPU) or smart NIC that includes a NIC and one or more processing cores. The network device 405 may also be implemented as a network switch that manages traffic between multiple network segments or planes.

The congestion control contexts may include variables and values that describe how congestion control operates for each network plane. In some cases, each congestion control context may receive feedback from the network, calculate congestion metrics, and maintain state information in memory. When a congestion indication is received, the processing core(s) 402 may recalculate congestion parameters compared to previous states and make decisions based on the specific context for each network plane or the unified context for single plane communications.

In some embodiments, a congestion control context may include a congestion window (cwnd) that determines the amount of data that can be transmitted before receiving an acknowledgment. The congestion window may be adjusted dynamically based on network conditions, increasing during periods of low congestion and decreasing when congestion is detected. For example, in a multi-plane configuration, each network plane may maintain its own congestion window value, allowing independent adjustment based on the specific conditions of that plane.

The congestion control context may also include a slow start threshold (ssthresh) that defines the boundary between the slow start phase and the congestion avoidance phase of the congestion control algorithm. When the congestion window is below the slow start threshold, the algorithm may increase the window size more aggressively. When the congestion window exceeds the slow start threshold, the algorithm may switch to a more conservative growth pattern. In some cases, different network planes may have different slow start threshold values based on their respective characteristics.

In some cases, the congestion control context may include round-trip time (RTT) measurements and smoothed RTT (SRTT) values that track the time required for data to travel to the destination and back. These measurements may be used to detect congestion and adjust transmission rates accordingly. For multi-plane configurations, each plane may maintain separate RTT measurements to account for different path characteristics.

The congestion control context may include packet loss counters that track the number of packets lost during transmission. These counters may be used to detect congestion events and trigger appropriate responses, such as reducing the congestion window or adjusting transmission rates. In multi-plane scenarios, separate packet loss counters may be maintained for each plane to provide independent congestion detection.

In some embodiments, the congestion control context may include acknowledgment tracking information that monitors which packets have been successfully received by the destination. This information may be used to determine when to retransmit lost packets and when to advance the transmission window. For multi-plane configurations, separate acknowledgment tracking may be maintained for each plane to ensure accurate state management.

The congestion control context may also include timer values that control various aspects of congestion control behavior, such as retransmission timeouts and delayed acknowledgment timers. These timers may be adjusted based on network conditions and may differ between network planes in multi-plane configurations.

In some cases, the congestion control context may include explicit congestion notification (ECN) state information that tracks congestion signals received from network devices along the path. This information may be used to proactively adjust transmission rates before packet loss occurs. For multi-plane configurations, separate ECN state may be maintained for each plane to respond to congestion signals specific to each path.

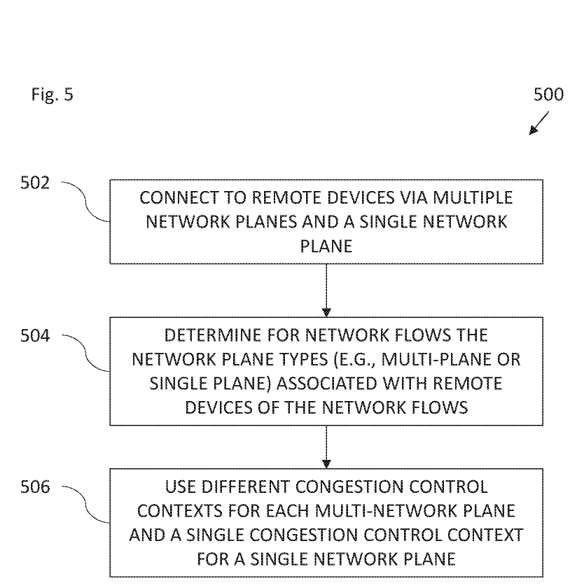

Reference is now made to FIG. 5, which illustrates a method 500 for managing congestion control across multiple network planes. The method 500 may be implemented by a network device to optimize congestion control strategies based on network plane configurations and remote device connectivity characteristics.

The method 500 begins with a step 502, where the network device is configured to connect to remote devices via multiple network planes and a single network plane. In some cases, the network device may establish connections through various network plane configurations to accommodate different types of remote devices and network topologies. The step 502 may involve the network device determining the available network plane options and establishing appropriate connections based on the capabilities of target remote devices.

The method 500 continues with a step 504, where the network device is configured to use data identifying network plane types of remote devices to determine whether network flows are associated with a multi-plane or a single plane network. The connection characteristics of the remote device associated with the network flow, i.e., whether the remote device connects via multi-plane or single plane networks, determine whether the network flow is associated with multi-plane or single plane. In some cases, the network device may receive data describing whether remote devices are connected to multi-plane or single plane networks. The network device may then determine for each network flow whether the remote device of that network flow is connected to a multi-plane or a single plane network. The step 504 may involve the network device examining network topology information, remote device capabilities, and connection requirements to identify the network plane types associated with specific network flows.

The method 500 proceeds to a step 506, where the network device is configured to use different congestion control contexts for each multi-network plane when communicating with remote devices connected to multiple network planes, and use a single congestion control context for a single network plane when communicating with remote devices connected to a single network plane. In some cases, the network device may maintain separate congestion control contexts to optimize traffic management across different network planes. The step 506 may involve the network device selecting between multiple congestion control contexts or a unified congestion control context based on the network plane configuration of the destination remote device.

In some embodiments, the method 500 may include additional steps for monitoring network performance and adjusting congestion control strategies. The network device may be configured to continuously evaluate network conditions and modify congestion control contexts as network topologies change or remote device configurations are updated.

Alternative embodiments of the method 500 may include variations in the sequence of steps or additional processing steps. In some cases, the network device may perform parallel processing of multiple network flows with different network plane configurations. The method 500 may also include steps for caching network plane configuration information to improve processing efficiency for subsequent network flows to the same remote devices.

The method 500 may be implemented using various congestion control algorithms and context management techniques. In some cases, the network device may store predefined congestion control contexts for different network plane configurations and select appropriate contexts based on flow requirements and remote device capabilities.

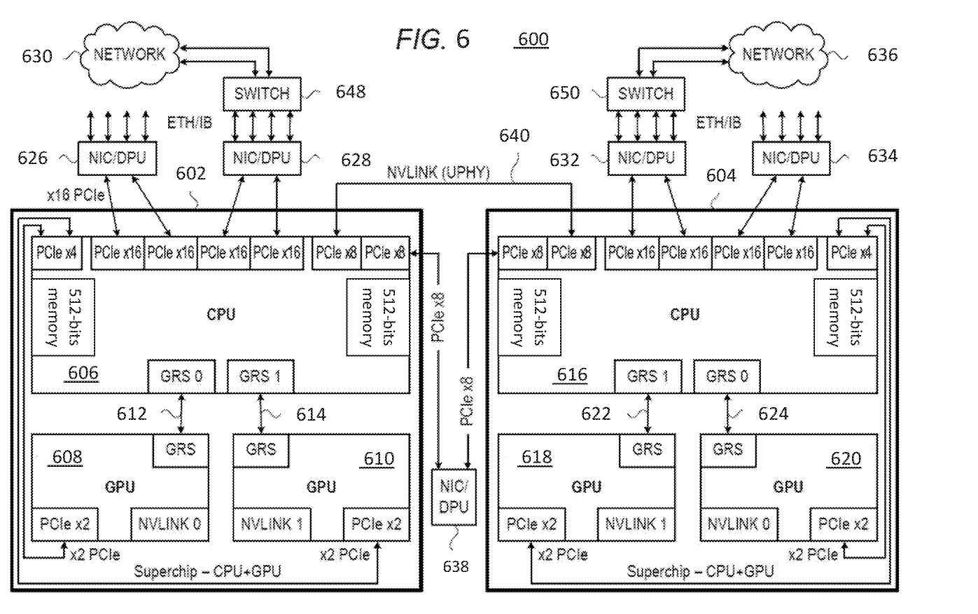

Reference is now made to FIG. 6, which is a block diagram that schematically illustrates a computing system 600, e.g., a data center or a High-Performance Computing (HPC) cluster, in accordance with an embodiment of the present disclosure.

System 600 comprises a plurality of subsystems, e.g., multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

The network device may be any suitable network device, e.g., a network interface controller (NIC) device, a data processing unit (DPU) or smart NIC including a NIC and one or more processing cores, or a network switch.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer’s motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer’s memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC’s operation, such as speed settings, interrupt configurations, and buffer sizes; firmware/ROM that contains the embedded software that controls the NIC’s operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the Figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A network device, comprising:
a network interface to send or receive a given network flow over a network; and
at least one processor to:
receive data associated with the given network flow;
automatically select a given congestion control algorithm from a set of congestion control algorithms based on the data of the given network flow; and
apply the selected given congestion control algorithm to control traffic of the given network flow.

2. The network device of claim 1, wherein the at least one processor is further to:
receive data associated with another network flow;
automatically select another congestion control algorithm from the set of congestion control algorithms based on the data of the other network flow, wherein the other congestion control algorithm is different from the given congestion control algorithm selected for the given network flow; and
apply the other congestion control algorithm to control traffic of the other network flow.

3. The network device of claim 1, wherein the data associated with the network flow comprises congestion control statistics, and wherein the at least one processor automatically selects the given congestion control algorithm based on the congestion control statistics.

4. The network device of claim 1, wherein the data associated with the given network flow comprises at least one round-trip time (RTT) measurement, and wherein the at least one processor automatically selects the given congestion control algorithm based on the at least one RTT measurement.

5. The network device of claim 1, wherein the data associated with the given network flow comprises application data, and wherein the at least one processor automatically selects the given congestion control algorithm based on the application data.

6. The network device of claim 1, wherein the data associated with the given network flow comprises quality of service (QoS) information, and wherein the at least one processor automatically selects the given congestion control algorithm based on the QoS information.

7. The network device of claim 1, wherein the data associated with the given network flow comprises information indicating a distance to a remote node associated with the given network flow, and wherein the at least one processor automatically selects the given congestion control algorithm based on the distance to the remote node.

8. The network device of claim 7, wherein the at least one processor is further to:
receive data associated with another network flow, the data comprising information indicating a distance to another remote node associated with the other network flow;
automatically select another congestion control algorithm from the set of congestion control algorithms based on the distance to the other remote node, wherein the other congestion control algorithm is different from the given congestion control algorithm selected for the given network flow; and
apply the other congestion control algorithm to control traffic of the other network flow.

9. The network device of claim 1, wherein the at least one processor is further to:
monitor performance metrics of the network flow while applying the selected given congestion control algorithm; and
dynamically switch to a different congestion control algorithm from the set of congestion control algorithms based on the monitored performance metrics.

10. The network device of claim 1, wherein the data associated with the given network flow comprises information about network topology between the network device and a destination of the given network flow, and wherein the at least one processor automatically selects the given congestion control algorithm based on the network topology information.

11. The network device of claim 1, wherein:
the network interface is to be connected to multiple network planes; and
the at least one processor is to maintain separate congestion control contexts for each of the multiple network planes when communicating with a remote device connected to the multiple network planes, and maintain a single congestion control context when communicating with a remote device connected to a single network plane.

12. A method comprising:
sending or receiving a given network flow over a network;
receiving data associated with the given network flow;
automatically selecting a given congestion control algorithm from a set of congestion control algorithms based on the data of the given network flow; and
applying the selected given congestion control algorithm to control traffic of the given network flow.

13. The method of claim 12, further comprising:
receiving data associated with another network flow;
automatically selecting another congestion control algorithm from the set of congestion control algorithms based on the data of the other network flow, wherein the other congestion control algorithm is different from the given congestion control algorithm selected for the given network flow; and
applying the other congestion control algorithm to control traffic of the other network flow.

14. The method of claim 12, wherein the data associated with the given network flow comprises congestion control statistics, and wherein automatically selecting the given congestion control algorithm is based on the congestion control statistics.

15. The method of claim 12, wherein the data associated with the given network flow comprises at least one round-trip time (RTT) measurement, and wherein automatically selecting the given congestion control algorithm is based on the at least one RTT measurement.

16. The method of claim 12, wherein the data associated with the given network flow comprises application data, and wherein automatically selecting the given congestion control algorithm is based on the application data.

17. The method of claim 12, wherein the data associated with the given network flow comprises quality of service (QoS) information, and wherein automatically selecting the given congestion control algorithm is based on the QoS information.

18. The method of claim 12, wherein the data associated with the given network flow comprises information indicating a distance to a remote node associated with the given network flow, and wherein automatically selecting the given congestion control algorithm is based on the distance to the remote node.

19. The method of claim 12, further comprising:
monitoring performance metrics of the given network flow while applying the selected given congestion control algorithm; and
dynamically switching to a different congestion control algorithm from the set of congestion control algorithms based on the monitored performance metrics.

20. The method of claim 12, wherein the data associated with the given network flow comprises information about network topology between a network device and a destination of the given network flow, and wherein automatically selecting the given congestion control algorithm is based on the network topology information.

21. The method of claim 12, further comprising maintaining separate congestion control contexts for each of multiple network planes when communicating with a remote device connected to the multiple network planes, and maintaining a single congestion control context when communicating with a remote device connected to a single network plane.
